(19) United States
(12) Patent Application Publication
(10) Pub. No.: US 2004/0064436 A1
(43) Pub. Date: Apr. 1, 2004

(54) System and method for managing business continuity

(76) Inventors: Jodi Breslin, Great Neck, NY (US); Graham deGottal, Readington, NJ (US); Evelyn Borgia, Havppange, NY (US)

Correspondence Address: Michael J. Scheer, DICKSTEIN SHAPIRO MORIN & OSHINSKY LLP, 41st Floor, 1177 Avenue of the Americas, New York, NY, 10036-2714, US

(21) Appl. No.: 10/619,496

(22) Filed: Jul. 16, 2003

Related U.S. Application Data
(60) Provisional application No. 60/396,179, filed on Jul. 16, 2002.

(51) Int. Cl. G06F 7/00

(52) U.S. Cl. 707/1

(57) ABSTRACT

A system and method for developing, assessing testing and implementing plans and procedures for managing crisis events and providing continuity to business operations in cases of business interruption. Such business interruption can occur due to a variety of reasons including physical facility emergency. The continuity in business operations relates at least to real estate, and critical business resources such as computers, databases and applications. The system includes a core repository that manages, monitors and measures all core continuity processes across an institution (e.g., a corporation). Once an emergency had been identified, the system links the continuity plans to crisis team initiatives across the corporation. The system provides an executive level ‘state of health’ reporting facility to enable executives (managers) to assess the state of the business and the execution of the continuity plans in real time.

### CROSS REFERENCE TO RELATED APPLICATIONS

This application claims priority to U.S. Provisional Application No. 60/396,179, filed on Jul. 16, 2002, the entirety of which is incorporated herein by reference.

### FIELD OF THE INVENTION

The present invention generally relates to systems and methods for managing business continuity, and more particularly to systems and methods for identifying business critical resources and developing procedures to ensure continuity of business operations in the case of business interruptions.

### BACKGROUND OF THE INVENTION

Everyone has participated in fire drills. Those of us that are old enough, recall bomb preparedness drills. Certain areas of the country have flood preparedness as others have ice and snow storm contingency plans, while yet others have earthquake contingencies. As the tragic events of Sep. 11, 2001 brought glaringly home, we must now also be prepared for the occurrence of the unthinkable. Although most businesses have some sort of plan for evacuation of physical facilities in the case of an emergency, these plans are typically inadequate and almost always out of date. Most plans do not have adequate procedures for accounting for the enterprise's personnel. Furthermore, apart from the government mandated fire drills, very little education of employees occurs with respect to such plans.

Although most business have at least some sort of plan with respect to the physical safety of its people and its equipment, few have developed procedures for actual management during the crisis or adequate recovery plans or plans. Even fewer enterprises have procedures for continuity of the business in the event of a catastrophic occurrence that precludes the business from re-entering its physical facility for days, weeks or even months. Most such plans have revolved around the concept of risk management.

Risk management relates to procedures for assessing and managing risk that are established by the enterprise, with accompanying directives by management to comply with the procedures. For example, a given manager of a department may be required to establish the, level of risk associated with the operation of a particular computer system (e.g., the risk of losing use of such a computer system for some period of time). This manager may formulate a system for evaluating and reporting the risk, that can be used by lower level and project managers. For example, on a periodic basis such as quarterly, the managers for a given department might be required to communicate to upper management the various risk factors and risk evaluations that are related to its computer information systems operations. The risk factor related information can be documented through various forms or questionnaires for evaluating risk and risk factors associated with projects for which they are responsible. These forms and questionnaires can be compiled into reports and other summary data to provide a department manager with a fairly good idea of the level of compliance with various enterprise procedures.

Typically, if a group within the department is not in compliance with the established procedures for the enterprise, this information can be so noted in the summary or compiled data presented to the department manager. In such a case, the department manager can establish plans to bring the group into compliance, and to monitor the status of the group in progressing with the plan.

The impact of evaluating the risk for a given enterprise can have serious consequences with regard to the success or profitability of the enterprise. For example, if an enterprise fails to adequately assess the impact of the loss of a particular facility for some period of time, such a loss can catastrophic to the business. In addition, if the enterprise has established procedures that are designed to protect the enterprise from liability, or otherwise assure that levels of risk within the enterprise are minimized, the enterprise can be exposed to tremendous liability if the procedures are not properly followed. For example if the enterprise has contractual obligations that could only be met through the use of a particular facility.

In typical enterprises, the analysis, statuses and reporting to upper management of the procedures with respect to crisis management and business recovery are often haphazard, and inconsistent. For example, some managers may find the requirement of filling out forms and answering questionnaires to be an inefficient use of time, and fail to effectively complete risk assessments. Other managers may take the attitude that ‘it can't happen here’. Furthermore, most departments fail to evaluate the external dependencies that it has, and the impact on its ability to perform its functions should those external entities experience a catastrophic event.

Where such tool for these types of risk assessments do exist., they tend to be form intensive, and inconsistent between various enterprise locations. It is difficult to track and maintain the data that can be obtained from forms related to assessment of risk, and even more difficult to take an enterprise view of such risk, which is absolutely required for major disruptive events. Most such tools are paper based, which clearly are inadequate during an actual event and are similarly inadequate in recovering from such an event.

Some computer based systems have been developed to overcome the difficulties with traditional paper based risk assessment systems. It does not appear that any such systems have been developed with respect to planning, testing and activating contingency plans for the real time management of a crisis within a corporation, nor the subsequent recovery therefrom.

### SUMMARY OF THE INVENTION

The present invention is a system and method for developing and implementing plans and procedures for providing continuity to business operations in cases of business interruption. Such business interruption can occur due to a variety of reasons including physical facility emergency. The continuity in business operations relates at least to real estate, personnel, and critical business resources such as computers, databases and applications. A first step of the present invention is to create a core repository that manages, monitors and measures all core continuity processes across an institution (e.g., a corporation). The invention eliminates redundant systems and functions related to continuity within each of the Lines of Business (LOBs) with the institution. Once an emergency had been identified, a significant goal of the present invention is to link the thus developed continuity plans to crisis team initiatives across the corporation. The present invention provides an executive level ‘state of health’ reporting facility to enable executives (managers) to assess the state of the business and the execution of the continuity plans in real time.

The present invention utilizes a six-step continuity management system to develop, assess and test the continuity plans and readiness of each department with a corporation. The system identifies and tracks outstanding issues through final resolution or acceptance of the risk posed by the issue. The system provides the capability to run simulated exercises of the continuity plans. At the end of such a simulated continuity exercise, the system sends out service questionnaires to obtain measures of responsiveness and quality. The system then aggregates responses to the questionnaires into meaningful actionable measures.

During an exercise or actual event, the present invention allows management and a crisis team to access the real time issue tracking system from any location The system allows tracking of critical and non-critical staff at primary and secondary locations and identifies resources required to sustain a LOB business activity., The system furthermore reports on the status of these issue in real time at an executive level. The system produces a firm wide “heat map” during an exercise or actual event including corrective actions plans, risk acknowledgments and board issues.

The present invention provides integrated linkages to manage critical system continuity plans, business continuity plans and key Outside Service Providers (OSP) dependencies across LOBs. The system provides user friendly interfaces that are secure and easily integrated into a firm-wide portal. The system provides a repository to identify critical incidents and pending resolutions during an event. The system allows business managers and technologists to stage continuity scenarios and make conscious decisions around key processes, people, locations and critical business applications including production, development and Quality Assurance (QA) environments.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates a preferred embodiment of the system of the present invention;

FIG. 2 depicts the six step method of the present invention;

FIG. 3 is an input screen for describing a business;

FIG. 4 illustrates the method of assessing the criticality of the continuity of a business operation;

FIG. 5 illustrates the input screens for describing department resources;

FIG. 6 illustrates an input screen for assigning and viewing personnel assigned to roles;

FIG. 7 is method for using the VRU feature of the present invention;

FIG. 8 illustrates an input screen 600 for assessing a Crisis Management Program plan;

FIG. 9 illustrates an input screen 600 for assessing the testing of a Crisis Management Program plan;

FIG. 10 illustrates an input screen 600 for the activation of Crisis Management Program plan;

FIG. 11 illustrates a State of Health Report Card status screen; and

FIG. 12 illustrates a legend to the icons depicted in FIG. 11.

### DETAILED DESCRIPTION OF THE INVENTION

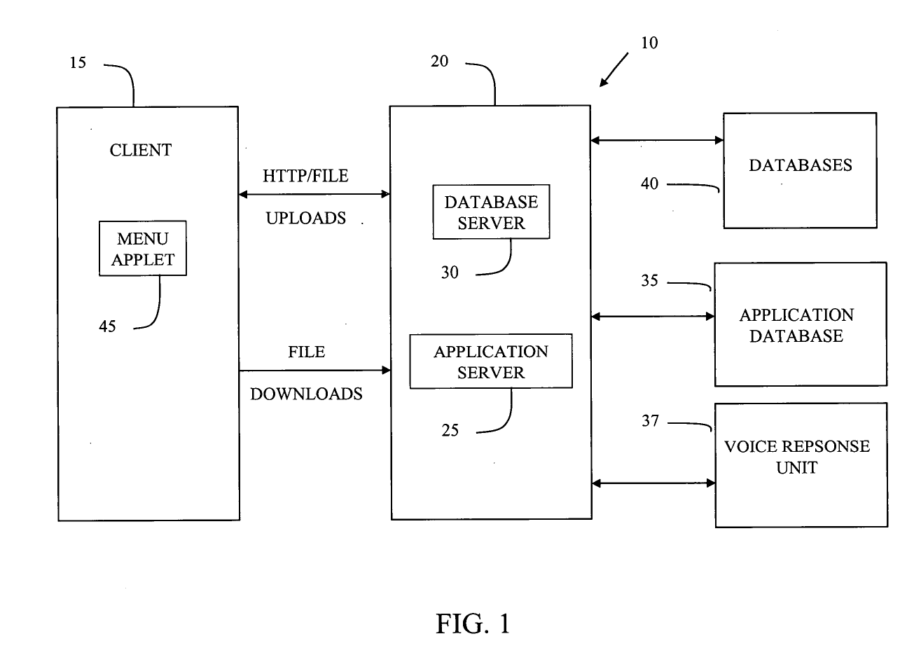

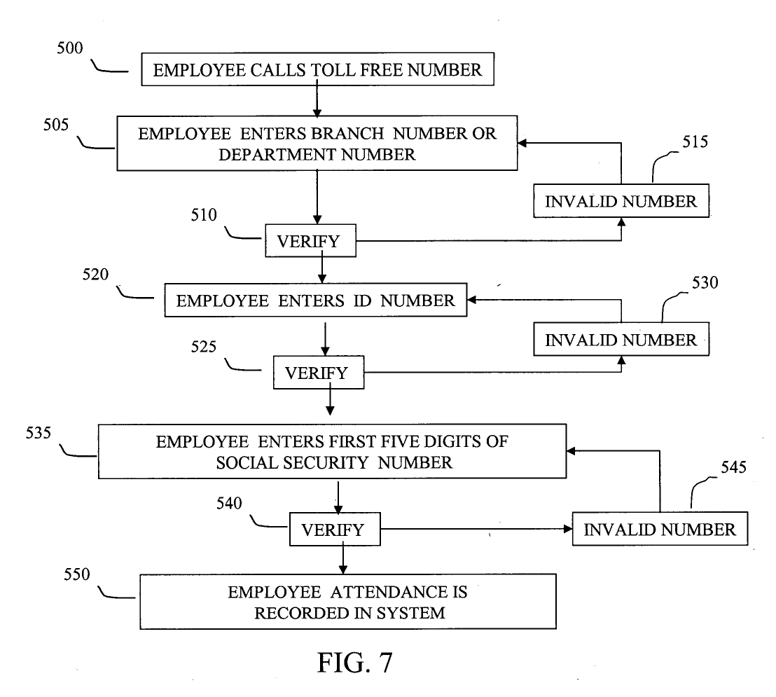

The system 10 of the present invention is illustrated in FIG. 1. As illustrated, system 10 is implemented using a distributed client/server architecture. The clients 15 (one illustrated) are distributed throughout the enterprise (corporation), while the servers 20 are centrally located with redundancies (not illustrated). This infrastructure consists of one application server 25 communicating with application database 35, and one database server 30 communicating with database 40. In a preferred embodiment, the application server 25 is running BEA WebLogic 5.1 that comprises middleware between the front-end web application and the application database 35. In this preferred embodiment, database server 30 is running Oracle 8.16 Server and database 40 is an Oracle database. Voice Response Unit 37 is connected to the servers 20. the function of Voice Response Unit 37 will be further described with respect to FIG. 7.

In the preferred embodiment, client 15 is a web based browser application. This application 15 preferably uses browsers that support Java applets and JavaScript such as Netscape 4.x or Internet Explorer 4.x. Menu applet 45 is an illustration of a Java applet supported in client 15.

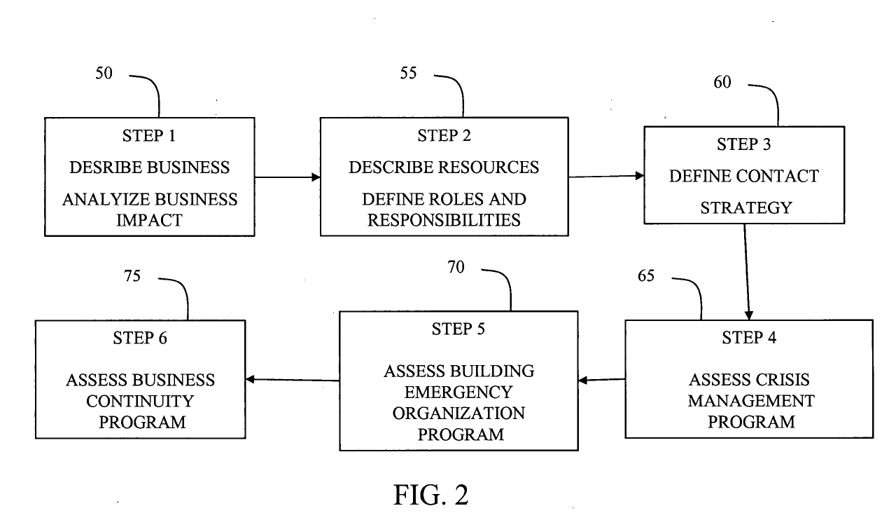

FIG. 2 broadly describes the six step method of the present invention. The method enables tracking of continuity resources across the enterprise and the six-step map provides for consistency and standardization throughout the organization. The six step method further provides a comprehensive self-training exercise and fosters the sharing of essential business profiles, continuity risk acknowledgments, “proven” compensating controls and best practices across the organization.

In steps one, two and three (50, 55, 60) a manager of a particular department within a particular LOB within the enterprise describes his/her department and the resources used and controlled thereby. The responsibility for describing the department and its resources is assigned to the manager of the department, as this is the person in the organization with the most intimate knowledge about the current state of the department at any given time. As further described below, the information for each department is aggregated and rolled up for each higher level of management with the organization. In steps four, five and six of the method (65, 70, 75) the manager of the department is required to assess the state of the procedures in place with respect to three separate programs, namely Crisis Management 65, Building Emergency Organization 70, and Business Continuity 75.

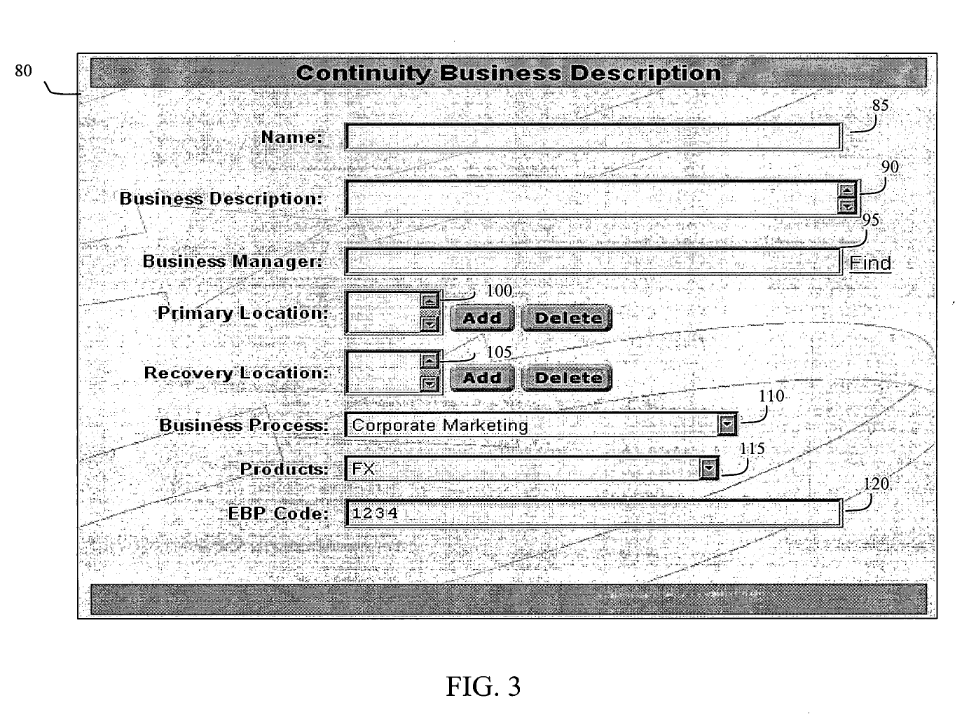

FIG. 3 illustrates an input screen 80 used by a department manager to describe her business unit. In field 85, the manager fills in the name of her department. Field 90 is used by the manager to describe her department. A listbox is available to assist the manager in filling in this field 90. In a preferred embodiment of the present invention, the manager uses a free form text in field 90 to describe the role of the department. For example, a particular manager nay enter the following business description to describe her department “Manage the corporate Continuity program by providing processes and tools to JPMC community; Provide customized MIS Reporting for the HR community; Originations Processing, Implement and manage eCommerce Technology for Online Banking services.”

In field 95, the manager inputs her name. Field 100 is used for the manager to identify the primary location at which the people in her organization are located. As with field 90, a listbox listing locations already defined in the system is available to assist the manager in inputting the location correctly (e.g., eliminates misspellings, wrong street addresses . . . ). There are also ADD and DELETE buttons provided on screen 80 for the user to add (or delete) entries that are not in the system (or are erroneously in the system).

In field 105, the manager is requested to input the recovery location for her department. The recovery location is the physical location where the members of the manager's department would report to work in the case of a disruption at the department's primary location. It is envisioned that the recovery locations are to be used in the case of longer term outages. As further discussed below, the phrase “longer term” is relative with respect to the criticality of the particular department. In the case of a critical department, long term might mean anything more than a few hours. Other departments might be able to function without a recovery location for a period of a few weeks (e.g., working from home). One of the purposes of identifying the recovery location of all departments is to identify initial and sustained staff requirements with the ability to track real estate availability in the plan, test and activate modes for personnel relocations. The system 10 insures integrated linkages to manage critical system continuity plans, business continuity plans and key internal and external dependencies.

Business process field 110 is used to provide a common definition for the function that a department performs. For example, a department's primary function might involve corporate marketing, risk management, transaction processing, trade execution, and/or telephone customer service. This field 110 could be used when querying LOBs to find similar functions where perhaps continuity plans could be leveraged. For example, there might be two departments in different divisions that both perform trade execution. The contingency plans for one of the departments may be completely applicable to the other. In such a case, the system and method of the present invention identifies such commonality and allows the elimination or at least a reduction in wasteful creation of redundant contingency plans. Again, a list box is available to assist the manager in choosing the appropriate entry for this field.

Products field 115 allows the manager to identify the products (services) which are supported by the particular department. Essential Business Process (EBP) field 120 receives a unique code that identifies the LOB. In the preferred embodiment, the unique identifier code is comprised of two alpha characters (a sector code) and four numeric characters (aligned to a LOB). The EBP process is a complimentary process to the present invention which includes a database that inventories (if populated by the business) the business impact analysis along with the ability to populate the types of services required by a LOB in the event there is a loss or disruption of service. As there is a similarity between the EBP process and the present invention, the system of the present invention includes this field as cross-reference containing the respective codes. Linkage can be provided to the complimentary EBP corporate-owned database.

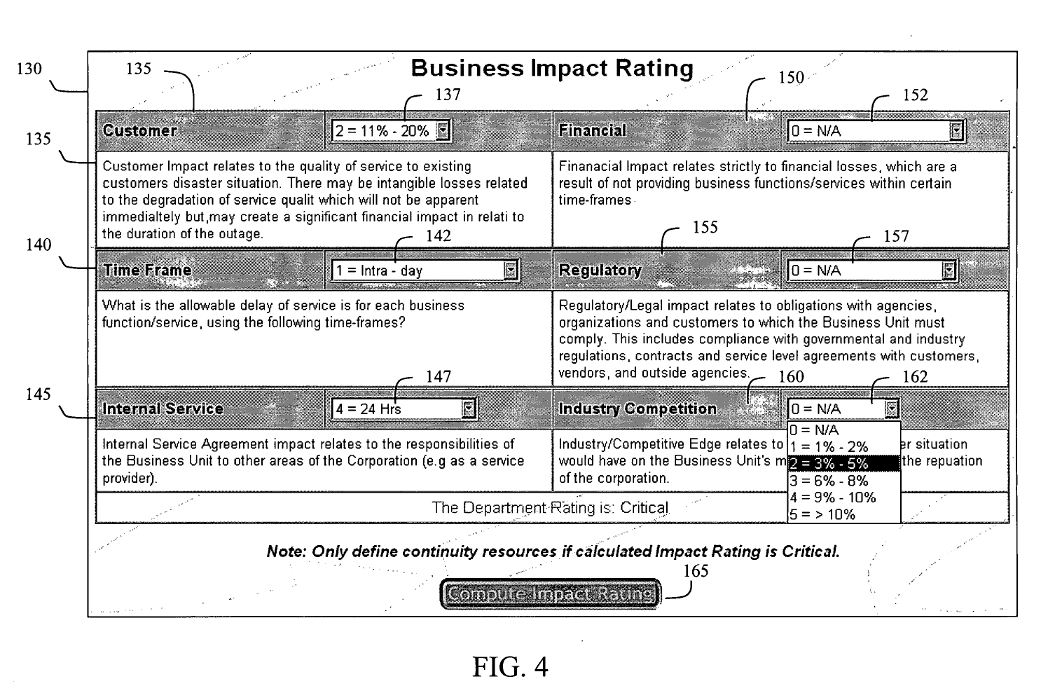

Once the manager has described her department to the system 10 as illustrated in FIG. 3, she must then make an assessment of the relative criticality of the department to the organization. Although all managers inherently believe their department to be critical to the success of the organization, the method of the present invention attempts to take the subjectivity out this assessment to the extent practicable. System 10 does so through a series of individual assessments, from which an overall impact rating for the department can be derived. System 10 enables businesses to assess criticality via a comprehensive information technology impact analysis. The classification focuses on loss of customer service, loss of revenue or increased operational expense, regulatory and legal penalties stemming from contractual obligations, loss of services among internal partners, and loss of competitive edge specific to visibility and industry edge. These individual impact assessments are illustrated in FIG. 4. FIG. 4 specifically illustrates an input screen 130 that a manager can use to assess the impact if her department had to cease operations for some period of time.

The first impact rating 135 relates to the impact of the department under assessment with respect to the organization's customers. Specifically, the Customer Impact Rating 135 asks the manager to assess the impact in the quality of service to existing customers that the department would be able to provide in a disaster situation. The assessment 135 notes that there may be intangible losses related to the degradation of service quality which will not be apparent immediately but, may create a significant financial impact in relation to the duration of the outage. List box 137 allows the user to view all of the available choices by which to answer the Customer Impact Rating 135. These possible answers include: “0” for not applicable (in the case where the department is an internal only organization); “1” for where the manager believes there would be a 1 to 10% decrease in the quality of service provided to the customers in a disaster situation; “2” for where the manager believes this degradation would be 11 to 20%; “3” where the envisioned degradation is 11-30%; “4” for a degradation of 31-40%; and rating of “5” where the degradation of the impact on the customer is greater than 40%. The specific ranges identified for responses for this field are presently preferred, and it is readily appreciated that these ranges can be modified to suit a particular business and/or objective. The Customer Impact Rating 135 relates to the quality of service to existing customers during a disaster situation. Again, there may be intangible losses related to the degradation of service quality, which will not be apparent immediately but, may create a significant financial impact in relation to the duration of the outage.

Time Frame Rating 140 asks the manager for the allowable delay of service for her department. The first option available for the manager to choose in list box 142 is “More than one week”. This indicates that the department does not have to be back up and running in any time-frame greater than the one week definition. The remainder of the impact ratings with respect to Time Frame Impact include: “1” where the department must resume operations within one week, (e.g., between days 3 and 7); “2” for 48 hours where it is acceptable to resume operations by the start of the business unit's second business day; “3” 24 hours, where the operations of the department must be resumed by the start of the business unit's next business day; “4” Intra-day, where resumption of operations can take place before the end of the business unit's business day. (i.e. 4 to 8 hours); and “5” Immediate, where the operations of the business unit must resume within 4 hours. The specific ranges and choices identified for responses for this field are presently preferred, and it is readily appreciated that these ranges can be modified to suit a particular business and/or objective.

Internal Service Agreement impact 145 relates to the responsibilities of the Business Unit to other areas of the Corporation (e.g. as a service provider). For example, the internal legal department would be a service provider to other departments in the organization. List box 147 provides the user with the range of available ratings which includes: “0” for not applicable (in the case where the department is not an internal service provider) The other acceptable choices for input into Internal Service Agreement impact 145 field are defined in terms of a time frame. The Time Frame Rating field 140 described above is a determination of how quickly the corporation needs to have available each particular business function/service. The Internal Service Agreement impact field 145 relates to the responsibilities of the department to other areas of the enterprise (e.g. as a service provider).

The other available ratings for input into Internal Service Agreement impact field 145 include: “1” 1 WEEK; “2” 1 WEEK; “3” 48 HRS.; “4” 24 HRS.; and “5” INTRA DAY. The specific ranges and choices identified for responses for this field are presently preferred, and it is readily appreciated that these ranges can be modified to suit a particular business and/or objective.

Financial Impact 150 relates strictly to financial losses, that would be a result of not providing business functions/services within certain time-frames. The timeframe for the calculation of the financial loss is preferably based upon a thirty (30) day outage. The selections in list box 152 include: “0” for N/A; “1” if the financial impact is estimated to be less than $500,000; “2” if the loss is between $500K and $1 million; “3” for expected losses of $1M to $2.5 M; “4” for losses of $2.5M to $5M; and “5 for estimated losses of greater than $5M. The specific ranges and choices identified for responses for this field are presently preferred, and it is readily appreciated that these ranges can be modified to suit a particular business and/or objective.

Regulatory/Legal impact field 155 relates to obligations with agencies, organizations and customers that have laws, regulations or rule with which the user's business unit must comply. This includes compliance with governmental and industry regulations, contracts and service level agreements with customers, vendors, and outside agencies. List box 157 enables the user to select from several impacts that describe the legal or contractual penalties that would result from non-compliance by the department due an interruption in the business. These ratings including: “0” for N/A; “1” for a $50,000 penalty; “2” for a $50K to $100K penalty; “3” for a $100K to $500K penalty; “4” for a $500K to $1 million penalty; and “5” for a penalty of greater than one million dollars. The specific ranges and choices identified for responses for this field are presently preferred, and it is readily appreciated that these ranges can be modified to suit a particular business and/or objective.

Industry/Competitive Edge impact rating 160 relates to the effect a disaster situation would have on the particular business unit's market position and the reputation of the corporation. List box 162 gives the user the following choice for the estimated amount of impact on the market position and corporate reputation: “0” for N/A; “1” for 1 to 2% of an impact; “2” for 3 to 5% impact; “3” for 6 to 8% impact; “4” for 9 to 10% impact; and “5” for any estimated impact greater than 10%. The specific ranges and choices identified for responses for this field are presently preferred, and it is readily appreciated that these ranges can be modified to suit a particular business and/or objective.

Once the user has provided an impact assessment for each of the six categories described above (135, 140, 145, 150, 155 and 160), the user clicks on button Calculate Impact Rating 165 in order to calculate the overall impact rating of the department. System 10 computes criticality rating for the department from the number input by the manager in the categories described above. The analysis process results in a rating of 0 to 5 (low to high criticality), for each of the impact criteria. A determination of a “summary” rating is based on the highest criticality rating of the individual impact criteria. The Department Rating is: Critical (if any rating is 3, 4 or 5) or Non-Critical (if all ratings are 2 or less). The specific algorithm used to analyze the overall criticality of the department (in light of the manager's assessment) is subject to the goals of the business. For certain types of businesses, certain departments will more critical than others. For example, the restoration of the MIS department will be much more critical to a financial services business than it will be to a steel manufacturer.

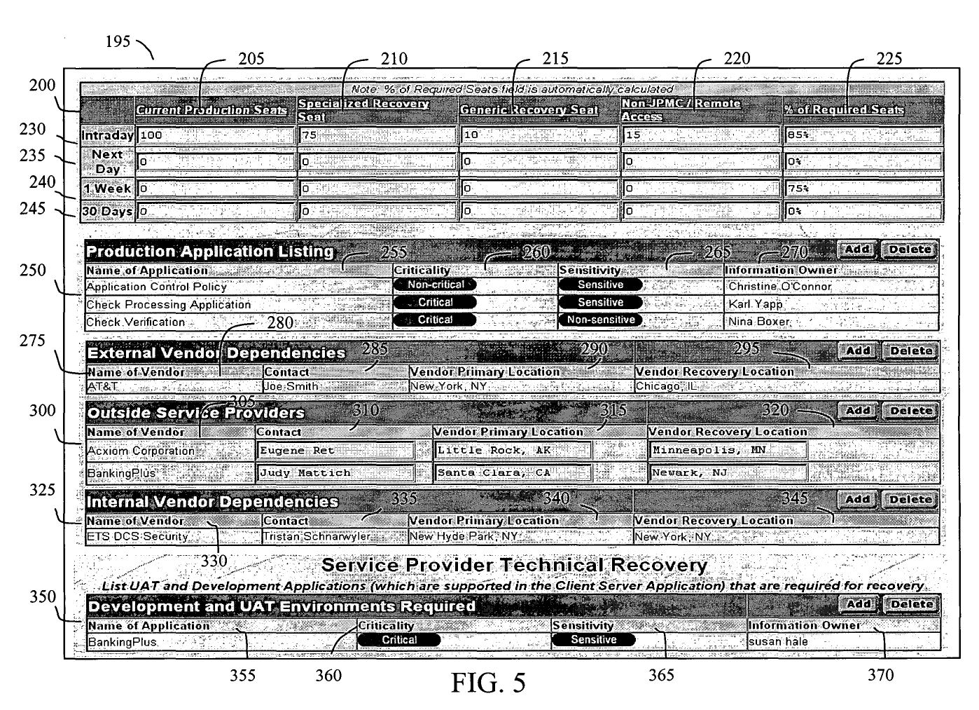

If a department is found to be critical, it must then go on to describe the resources that it requires to perform its functions. Specifically, it must define the “seats” it requires, the applications, external vendor dependencies, outside service providers and internal service providers. FIG. 5 illustrates a compilation of input screens 195 that assist the department manager in describing the resources of her department. As described below, input screens 250, 275, 300, 325 and 350 can each be expanded to include as many records as necessary for the manager to completely describe the resources of the department.

The first input screen 200 allows the manager to describes the “seats” required by the personnel in the department to accomplish the department's mission. “Seats” in this context means a physical work location (i.e., a physical seat) as well as the facilities required to perform the department's functions such as a computer, a phone, network connections as well as access to copiers, facsimile machines and other facilities typically associated with the performance of a modern day office job.

The manager is required to input the specific number of each type of seat required by the department. Specifically, the manager inputs the number of Current Production seats 205, Specialized Recovery seats 210, Generic Recovery seats and Non-Employee/Remote access seats 220. Current Production seats 205 refers to the actual number of critical and non-critical seats occupied during normal operating hours. Specialized Recovery seats 210 are the seats that are equipped with specialized technology and equipment to meet the needs of the business (e.g., a trading workstation). Typically, this type of recovery seat is “dedicated” to a particular LOB or type of function. Generic Recovery seats are seats that are equipped with the basics (e.g., a Personal Computer, phone, etc.) which can be pointed to the applicable recovery infrastructure. Typically, this recovery seat can be “shared” or used by different LOBs (e.g., back office operations). Finally, Non-Employee/Remote access seats 220 refers to the number of individuals who do not need to relocate to a formal recovery site. These individuals require “remote access” (e.g., from home via VPN/dial-in access) to the recovery infrastructure.

In order to plan for business continuity and disaster recovery, the manager is asked to estimate the number of each type of seat that is required by her department, and the schedule by which these seats must be recovered. Specifically, the manager is asked for the number of seats required on an Intraday basis 230, by the next day 235, within a week 240 and within a month 245. This information allows the organization to effectively plan its physical resources in the case of an emergency. One significant benefit of this process is that it prevents ad-hoc allocation of physical resources in an emergency. During an emergency, resources are no longer allocated on a ‘we got here first’ basis, but rather such resources are allocated on a basis that resumes operations of the organization as a whole in quickest and most efficient manner.

Field 225, Percentage of Required Seats is calculated by system 10. This field represents the number of current production seats divided by the total of specialized and recovery seats. This total is computed when a contingency exercise is activated and depends on the nature of the contingency—i.e., intraday, next day, one week and 30 days. The amount of seats needed to plan for varies based upon the number of days required.

Input screen 250 is used by the manager to list the software applications that it requires to have to access to from its alternate location In field 255, the manager selects the applications needed by clicking on the “Add” button. The application name is chosen from this drop-down field 255 which lists all applications from an application portal. [Note to Inventors: what is the “application portal?” We need to include a description of this facility as we use it here and several times below] If an application is not on the drop-down list then it can be manually added by the user. If an application is manually added by the user, an exception notification is sent to the system Administrator and respective Information Risk Manager or Continuity Coordinator indicating that a review must be performed on that application or inputted into the Application Portal. Fields 260, 265 and 270 are automatically extracted from the Application portal. Field 260 identifies whether the application is considered to be critical or non-critical.

All of the data input by a manager is stored in a database as described above with respect to FIG. 1. As previously described, this allows all of the data for all departments to be rolled up and aggregated for providing complete and accurate reporting capabilities as well as for use in testing and in real disaster situations. An additional benefit of the centralized database is that it provides for uniformity in data input, specifically terminology, across departments. For example, on department might call a particular application by a particular name, while a different department may call the same application by a different name. The centralized database allows (requires) uniform naming of the application throughout the organization. The same uniformity applies to most other inputs into the system (names, addresses . . . ) As described above, input screens 250, 275, 300, 325 and 350 provide add and delete buttons to allow the users to add and records to the system.

Input screen 275 is used by the manager to identify the external vendors on which the department depends. As illustrated in the figure, AT&T would be an example of an external vendor. For each identified external vendor, the manager is required to input a Contact 285 at the vendor, the Vendor's Primary Location 290 and the Vendor's Recovery Location 295. The purpose of identifying the primary and recovery locations of external vendors is to provide the system with the capability, in an emergency situation, to assess whether or not (or when) a particular department can resume operations with its external vendors. For example, if the vendor's primary location is in the same zone (described further below) as the department's primary location, in the case of a flood in the zone, it would be reasonable to assume that the external vendor will also not be operational.

Furthermore, identification of the external vendor's recovery location will enable the organization to assess whether or not the external vendor is adequately prepared in the case of a disaster. For example, if the external vendor has no recovery location, the firm might decide to use another external vendor with adequate recovery procedures, or might pressure the existing external vendor to develop such a recovery site.

Input screen 300 is used by the manager to identify the outside service providers (OSP) on which the department depends. An external vendor, as described above, is a supplier to the business, like in the case of the above example of the telephone company. An OSP is an outside organization that is not owned or controlled by the business, and has been retained to process or store information for the business, provide production support, provide remote network management/monitoring services, develop or maintain applications and/or systems, or provide call center/service center services. Generically, an OSP is providing a service that the business can do or has done in the past in house, but has outsourced to the OSP. In the case of a banking institution, processing activities include the origination, processing, and settlement of payments and financial transactions, information processing related to customer account creation and maintenance, as well as other information and transaction processing activities that support critical banking functions, such as lending, deposit-taking, fiduciary, or trading activities.

FIG. 5 illustrates two such OSPs. Although not illustrated in this figure, input screen 300 (as well as input screens 250, 275, 325 and 350 all allow for additional rows for additional entries (e.g., additional OSPs). For each identified OSP, the manager is required to input a Contact 310 at the OSP, the OSP's Primary Location 315 and the OSP's Recovery Location 320. As with the identification of an external vendor's primary and recovery locations 290, 295 described above, identification of the OSP's primary 315 and recovery locations 320 provides the system with the capability, in an emergency situation, to assess when (or whether) a particular department can resume operations with its OSPs.

Similar to input screen 250 for external vendors and input screen 300 for OSPs, the manager in screen 325 is required to identify the Internal Vendor Dependencies. As implied by the title, internal vendors are the service or product suppliers from within the corporation on which the department depends (e.g., the legal department). For each identified internal vendor, the manager is required to input a Contact 335, the internal vendor's Primary Location 340 and the internal vendor's Recovery Location 345.

Input screen 350 is used by the manager to list the software applications in development and test. Similar to the production application listing described above, where the data for the describing the application is extracted from the application portal, the application portal also provides lists of the applications in development and test (not yet in production. In field 355, the manager selects the name of the application from the drop-down options (click on “add”). Field 360 identifies whether the application is considered to be critical or non-critical and is automatically pulled from the application portal. Field 365 identifies whether the application is sensitive or not non-sensitive (critical). This identification is automatically pulled from the application portal. Finally, field 270 is used to identify the information owner of the application. Again, this information is automatically pulled from the application portal.

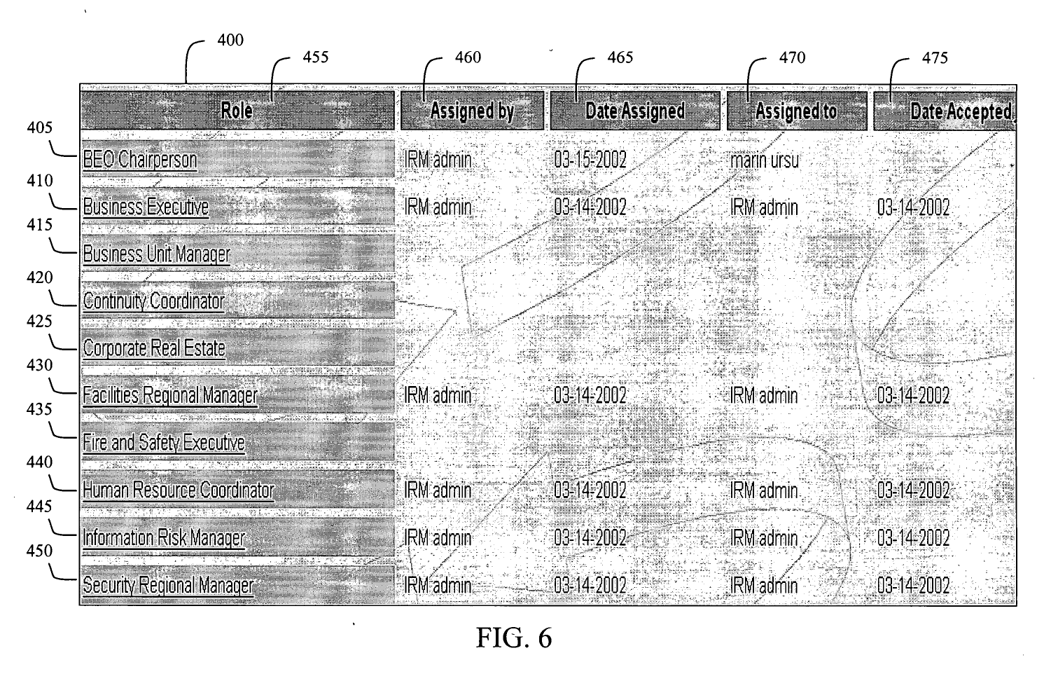

Once the manager has identified all of the resources on which it depends, the next step (second half of step 2 in FIG. 2) is to define the roles and responsibilities relative to the department in the case of business interruption (e.g., a disaster). FIG. 6 illustrates an input screen 400 for assigning personnel to the respective roles. This Figure illustrates ten different roles to be fulfilled in the case of an emergency: Building Emergency Organization (BEO) Chairperson 405; Business Executive 410; Business Unit Manager; Continuity Coordinator; Corporate Real Estate; Facilities Regional Manager; Fire and Safety Executive; Human Resources Coordinator; Information Risk Manager; and Security Regional Manager. Although ten roles are illustrated in the Figure, as further described below, there are many additional roles that need to be fulfilled in a crisis in order to ensure safety of the employees of the corporation as well as continuity of the business.

For each of the roles 455, input screen indicates who performed the assignment of the role 460, when the role was assigned, to whom the assignment was made 470 and the date on which the assignment was accepted 475. When an assignment is made, system 10 preferably sends the assignee an email notifying the person of the assignment and the responsibilities associated therewith (see below). The assignee preferably accepts the assignment by replying affirmatively to the email and system 10 updates the applicable database to record the assignment. When a manager is making assignments in input screen 400, some of the roles will have already been pre-populated as certain of the assignments relate to firm-wide or building-wide responsibilities (e.g., BEO Chairperson 405).

The following section describes the responsibilities of key ones of the roles in the present invention.

The BEO Chairperson 405 is the senior business executive or country manager from the building location. The responsibilities of the BEO Chairperson 405 include: Identifying an alternate Chairperson, preferably selected from the corporation's business executive team; Overseeing the recovery activities of the businesses impacted by the affected site; Notifying the Corporate Crisis Management Team (CCMT) (see below) and providing them with recovery status throughout the event (this responsibility requires maintaining a presence at the affected site until all personnel are evacuated. If this responsibility is delegated, the individual assigned must be equipped with a cell phone and pager); Working with the executives of the various lines of business to prioritize resumption of critical functions at the affected site; Developing, scheduling and executing semi-annual team awareness sessions; Performing a floor-by-floor review to ensure all areas of the facility are represented on the BEO team; Compiling contact information for each member including: Work number(s), Home number(s), Pager/Cell phone number(s); Communicating with the-CCMT and knowing how to contact this group during an incident; Identifying an “interim” staging area in a nearby location for the BEO Team to gather briefly to assess the situation; Compiling a listing of all business units in a facility and their designated assembly areas, recovery sites or command centers; Identifying all persons with disabilities or other conditions that would prevent an employee from exiting the building by walking down the stairs (ensuring that appropriate procedures are in place to address any special needs in accordance with applicable Federal guidelines and local fire code requirements); Ensuring that action items are assigned with target dates to specific individuals/areas for follow-up.

Business Executive 410 is a selected business executive(s) from the building location. The responsibilities of the Business Executive 410 include: Identifying an alternate should the primary contact not be available; Working with the BEO Chairperson to assess the corporation's risk exposures as a result of the emergency; Declaring a disaster recovery condition, if necessary, based on the damage assessment reports; Coordinating with the businesses in the affected site in conjunction with their documented business recovery strategies; Working with the BEO Chairperson to prioritize the reentry of employees to the building; Maintaining contact information with BEO Chairperson, i.e. pager number, home phone number, etc.; Identifying the LOB emergency assembly areas and command centers; Performing a floor-by-floor review to ensure all areas of the facility are represented on the BEO Team; Compiling contact information for each member including: Work number(s), Home number(s), Pager/Cell phone number(s); Compiling contact information (e.g. work, home, pager, etc) for all business managers within their LOB at the facility; and Establishing procedures to disseminate information about the status of an event as well as to collect relevant recovery information from affected units.

Facility Regional Manager and Corporate Real Estate 425 are responsible for: Identifying an alternate should the primary contact not be available; Ordering partial or total evacuation, in conjunction with the Security Regional Manager; Determining the anticipated length of the outage after performing an initial damage assessment; Supervising the required activities to restore the affected site; Providing initial reports on the damage assessment and ongoing status reports on the anticipated restoration time frames to the BEO Team Members; Providing a listing by floor of all business units affected at the site; Coordinating with local police, fire or other public safety officials as well as with the Security Regional Manager; Determining, in conjunction with Security Regional Manager, when the site is approved for re-entry; and Representing the interests of and communicate status to third party tenants (if any)

Security Regional Manager 450 is responsible for: Identifying an alternate should the primary contact not be available; Ordering partial or total evacuation, if necessary, in conjunction with the Facility Regional Manager; Ensuring the immediate evacuation of the affected building occupants; Securing the affected site to protect company, employee and other occupants' valuables; Coordinating with local police, fire or other public safety officials as well as with Facility Regional Manager; and Determining, in conjunction with Facilities Regional Manager, when the site is approved for re-entry.

Human Resource Coordinator 440 is responsible for: Identifying an alternate should the primary contact not be available; Accounting for all affected employees; Coordinating efforts to seek out employees who are not accounted for; Assisting in the re-entry of employees to the workplace; Generating lists of names and emergency contact information for all staff at the affected facility; Maintain hard-copy printouts of employee contact information; Working with rest of team to ensure that evacuated staff sign-in when they reach their designated assembly area and also establish communication procedures for collecting this information from each site; In conjunction with LOB Executive Team, ascertaining whether staff have: safely exited the site; been referred for medical treatment/hospital; if so, name and location of hospital; been instructed to wait for further instructions, proceed to contingency sites or sent home; and Including in the procedures, any temporary and/or contract staff at the affected location.

Information Risk Manager 445 is responsible for: Identifying an alternate should the primary contact not be available; Providing the BEO Chairperson 405 with key recovery information; Assisting the Business Executives 410 by providing business resumption alternatives; Coordinating a Post Emergency Event Review; and Performing a floor-by-floor review to ensure all areas of the facility are represented on the BEO Team.

The Technology Support Representative is responsible for: Identifying an alternate should the primary contact not be available; Providing status of all supported technology in the affected site; Providing status on any LOB activated alternative processing arrangements supported by technology area; Coordinating crisis response for technology support staff and resources; and Communicating critical information to affected technology departments in other geographic locations (e.g. data center).

The Crisis Management Chairperson (Senior Executive) is responsible for: Identifying an alternate should the primary contact not be available; Scheduling and facilitating semi-annual crisis management; Notifying primary crisis team members of the incident; Coordinating communications flows between and among crisis team members and when necessary the site crisis situation manager; Updating corporate executive management of crisis situation and ongoing status; Coordinating the development of the corporate strategic and tactical plans to address a situation; Maintaining an action items list of situation issues that need follow-up and track status of actions to close a specific item; and Scheduling and facilitating situation status update meetings; Scheduling and coordinating post-mortem situation reviews (within 2 weeks after the stabilization of the environment).

The Corporate or Senior Continuity Executive is responsible for: Identifying an alternate should the primary contact not be available; Maintaining readiness of Crisis Management Command Centers; Periodically exercising the Crisis Management Command Centers components; Scheduling and facilitating semi-annual crisis management desktop drills; Activating and Deactivating Crisis Management Command Centers upon the direction of the Chairperson; Recording and maintaining action items; Providing the Crisis Team with key recovery information (plans, recovery sites, etc.) pertaining to the affected LOBs; Assisting the Crisis Team by providing business resumption alternatives; Maintaining and following-up on post-mortem outstanding issues.

The Enterprise Technology Services (ETS) Executive is responsible for: Identifying an alternate should the primary contact not be available; Activating the Technology Management Command Center upon direction of the Crisis Management Team (CMT); Providing status on assigned action items; Providing the CMT with details of ETS supported technology (telecommunications, data processing, desktop) in the affected site(s); Communicating the status of all ETS technology within the affected site(s); Activating any alternative processing arrangements; Communicating details of the alternative processing arrangements to the CMT; Coordinating voicemail broadcast messages along with Corporate Communications and Corporate Human Resources; Coordinating the restoration of ETS supported technology in the affected site(s); and Communicating completion status of ETS technology restoration efforts.

The Legal Executive is responsible for: Identifying an alternate should the primary contact not be available; Assisting in the activation of the Crisis Management Command Center upon the direction of the Chairperson; Making an initial determination whether specific legal or regulatory issues are raised by the incident; As appropriate, contacting Legal Department attorney(s) with necessary expertise; As the incident unfolds, providing analysis to the legal and regulatory risks and the appropriate resource to those risks; Providing liaison with regulatory authorities and other government agencies; Reviewing risks of litigation arising from the incident, and help developing strategies for minimizing that risk; Assisting, as appropriate, in the preparation of public statements regarding the incident; Following termination of the incident, assisting in the post-mortem analysis.

The Corporate Insurance Executive is responsible for: Identifying an alternate should the primary contact not be available; Assisting in the activation of the Crisis Management Command Center upon the direction of the Chairperson; Making initial determination whether specific insurance issues are raised by the incident and if so, notify the appropriate external insurance personnel (e.g., claim adjusters); As appropriate, contacting Corporate Insurance Services individuals with necessary expertise; As the incident unfolds, providing analysis to the insurance policy response to the event; Providing liaison with insurance brokers, insurance carrier and claims adjusters as well as the effected business or staff areas; Assisting other staff areas with recommendations that will insure that the company's recovery from its insures will be forthcoming; Assisting, as requested, in the preparation of public statements regarding the incident; Following termination of the incident, assisting in and coordinating the claim preparation.

The Communications Executive is responsible for: Identifying an alternate should the primary contact not be available; Ascertaining incident facts; Assessing injuries/damages/risks; Establishing communication links with key coordinators (crisis management, human resources, employee communication, and security); Establishing on-site communications presence, if appropriate; Briefing senior executive management in coordination with Crisis Chairperson; Developing initial messaging; Initiating/coordinating (with HR and others as appropriate) periodic messaging (with timetable) for hotlines and other communication media to ensure a message is posted to communication channels with respect to relevant information related to the incident; Interfacing (as appropriate/necessary) with News Media, Governmental Agencies (local, state, federal), Senior Executive Management in coordination with Crisis Chairperson, Employees (families, significant others, etc.) supporting Human Resources; Reviewing event facts and disseminating as appropriate; Consulting with senior executive management; and Participating in post-event analysis.

Returning to FIG. 2, in step 3 (element 60) the manager is required to develop a contact strategy for implementation during cases of emergency. At the heart of the contact strategy is the requirement that the manager insures that system 10 has as complete information regarding each employee as possible. To this end, a record in system 10 is created for each employee. This record preferably contains: the employee's name; primary work location, primary work region; primary work branch; primary work phone number; primary work facsimile number; pager number; PIN number for the pager cellular phone number; home phone number; alternate home (e.g., vacation); personal Internet addresses; alternate work location; alternate work address; and alternate work phone number. The individual is identified at this stage if they are considered first or second level support (e.g., essential or non-essential, or critical or non-critical). This is classification is important when there is a contingency event. The names and contact information of first level staff members can be extracted and queried by LOB, facility and zone.

With this information in hand, system 10 is capable of instantly creates calling trees and wallet cards which can be produced at one's desktop. A wallet card is a common tool used by corporations and is a physical card that can be kept in one's wallet or purse for reference in the case of an emergency. The wallet card typically has advice and tips for action during an emergency (e.g., ‘don't open hot doors’) but more importantly, the card has specific information such as hotlines, websites, emergency locations that the employee can use in such emergencies. One of the problems with the prior art is that the generation of these cards was typically centralized and distribution of the cards was difficult. Using system 10 of the present invention, each employee has the capability of printing the wallet card at his or her own workstation.

The information contained on the wallet card can also be used to develop a calling tree. Employees can perform sequential call notification if needed to communicate to staff members within a department, for example.

The input of all of the employees' personal information allows system 10 to maintains a comprehensive and up to date contact list including key corporate senior executives in addition to all senior LOB business executives. In addition to the above personal information such as phone numbers for office, home, alternate home (e.g., vacation), cellular, personal Internet addresses, pagers, the contact list for key executives includes an identification of the person's alternate/designee.

Having the above personal information in hand, there are well known methodologies for communicating outbound to a person. One significant drawback of the prior art though is the absence of an automated process for enabling a employee, consultant or customer to acknowledge his/her safety in the case of an emergency. Part of the system 10 is a means for employees, consultants or customers to notify the firm of his/her safety through a Voice Response Unit 37 that is fed back into a decision engine protocol in system 10 (see FIG. 1).

Although VRUs 37 are known in the art, utilization of such technology in conjunction with a systems such as system 10 is not. FIG. 7 illustrates the process employed in the case of an emergency (an event). In step 500, the employee calls a toll free number in order to let the corporation know that he is alive and safe. In step 505, the employee enters his branch or department number, which is verified in step 510. If the employee has entered an invalid branch or department number (step 515), he is requested to enter it once again. The employee's wallet card described above should have the employee's correct branch or department number printed thereon. In step 520, the employee enters his employee number, which is verified in step 525. If the employee has entered an invalid branch or department number (step 530), he is requested to enter it once again. The purpose of steps 505-530 to locate the employee's record in the database of system 10.

As a security measure, in step 535, the employee is requested to enter the last five digits of his Social Security number. Although unlikely, there is a possibility that a misfeasor might try to impersonate an employee checking into the system. The inclusion of Social Security number verification (step 545) would mitigate against this type of impersonation. Once the employee's Social Security number has been verified, the fact that the employee has checked into the system 10 following the event is recorded in the database of system 10. The manager of a particular department is then able to log onto the system 10 (preferably through an intranet or through a secure Internet connection) and immediately generate a status report and determine which of his employees have successfully reported into the system and the time at which the reporting occurred. This allows the manager to concentrate on the employees that have not yet reported in. For example, using the personal information described above, that is stored in the database of system 10, the manager is able to attempt contacting the employees through each of the available channels of communication (e.g., home phone, alternate home phone, pager, cellular . . . )

Returning to FIG. 2, once all of the information has been gathered from the managers regarding her department, her people and her resources, steps 4, 5 and 6 (elements 65, 70 and 75) relate to the planning testing and activation of the contingency operations with respect to three different types of events. Step 4 (65) relates to Crisis Management, step 5 (70) relates to Building Emergencies and step 6 relates to Business Continuity.

The Crisis Management portion 70 of the present invention provides planning testing and status information about Crisis Events and their impacts, if any, on enterprise related facilities. When a Crisis Event arises system 10 provides management with an information clearinghouse. It enables the organization's personnel, worldwide, to monitor the status of selected building infrastructure components, transportation systems, and other designated items that may impact the normal function of an enterprise related facility.

The Building Emergency Organization Program 70 ensure a timely and accurate business recovery and building restoration of an enterprise facility in the event of a disruption that forces the partial, full, temporary or permanent closure of the site. This program 70 coordinates the numerous activities and personnel required for the business recovery and building restoration at an affected building location. The program 70 further ensures official information regarding the assessment of the building outage and the anticipated recovery times are communicated to affected businesses from that facility.

The Business Continuity Program 75 addresses the continuity of business, operations and technology components of a business unit, including those critical services and functions provided by third parties. The testing portion of the program 75 ensures that the business contingency plans remain accurate, relevant and operable under current conditions. The plans are tested at least annually to demonstrate their workability, and to verify the effectiveness of alternative locations. The Business Continuity Program 75 further meets the comprehensive business resumption planning and testing requirements mandated by government regulators.

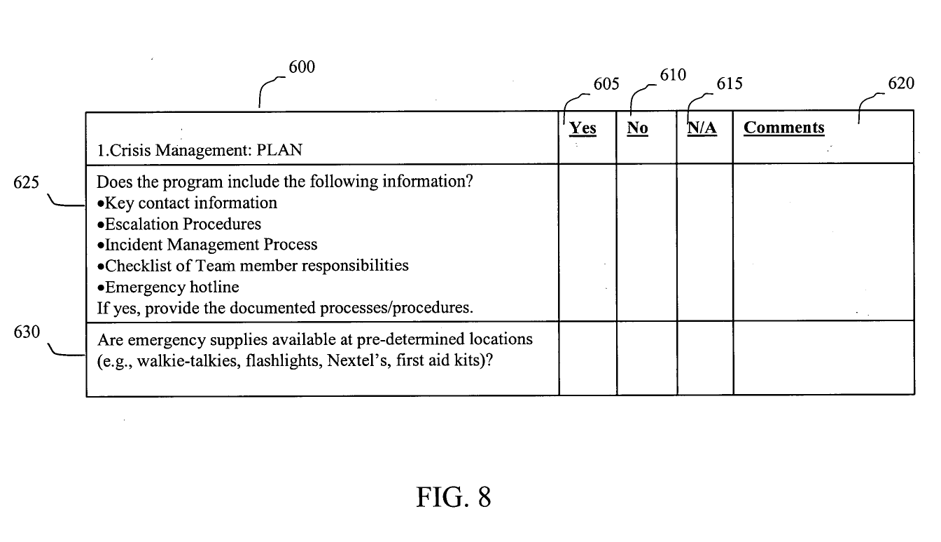

As described above, the purpose of the assessments in steps 4, 5 and 6 (65, 70 and 80) is to assess each department's readiness and performance of each of the Programs with respect to Planning, Testing and Activation of the program. This assessment takes the form of specific and explicit questions that are answered by the manager. FIG. 8 illustrates an example of an input screen 600 of system 10 for use by a manager in evaluating her department's plan with respect to the Crisis Management Program. Input screen 600 does not assist the manager in developing a crisis management plan, but rather assists the manager in assessing the adequacy of such a plan. The assessment takes the form of a series of questions 625, 630 to which the manager provides the answers Yes 605, No 610, or Not Applicable 615. The input screen 600 further provides the ability for the manager to enter comments in a Comments field 620. In addition to free form comments, the manager is also able to attach documents, such as a word processing document containing the department's crisis management plan itself.

In accordance with the present invention, a Crisis is determined when any of the following occurs: The possibility exists for negative press generation; The event has a domino effect causing serious violations of customer service level agreements and/or negative financial impact on the firm; An event affects multiple lines of business or support functions simultaneously; A contingency response plan is invoked; An event does not permit a timely recovery as defined by the business unit's continuity plan or defined customer service levels for the affected area; or Business resources, such as facilities, staff, and equipment, needed to perform the business processes, have been permanently or severely disabled.

The plan being evaluated by the manager in answering the questions in input screen 600 should have been developed with these types of crises in mind. In question 625 and 630, the manager must specifically answer whether or not the department's Crisis Management plan includes the following information: Key contact information; Escalation Procedures; Incident Management Process; Checklist of Team member responsibilities; and an Emergency hotline procedure. The manager is further asked whether there are emergency supplies available at pre-determined locations (e.g., walkie-talkies, flashlights, Nextel's, first aid kits).

When the manager provides a negative answer to any of the questions in any of the assessments in system 10, the system automatically asks the manager if she would like to develop a Corrective Action Plan (CAP) if the gap will be remediated within ninety days. As implied by its name, a Corrective Action Plan is a plan to correct the condition that has caused the manager to answer a question negatively. If the manager answers yes to developing a CAP, system 10 brings the manager to a CAP input screen in which the manager describes the condition which caused the negative response, the reason for the condition (e.g., funding) the plan to correct the condition, the person responsible for seeing that the correction is done, a target date by which the correction will be completed, and any attachments which are required to more fully explain the CAP. The CAP that is developed is stored in the database and appropriately linked to the records for this department.

If the manager says “No” when asked if she wants to develop a CAP, the manager is automatically brought to a Risk Acceptance screen. In this screen, the manager is required to describe the reasons for the requirement of the Risk Acceptance; what compensating controls are in place, if any; the likelihood of an impact due to the risk involved (high, medium or low); a description of the potential impact; a rating of the potential impact (catastrophic, severe, moderate, negligible); and an implementation plan. The Risk Acceptance by the manager is reviewed and approved by the appropriate LOB management. If the Risk Acceptance is not approved by management, a CAP must be developed in order to correct the risk condition.

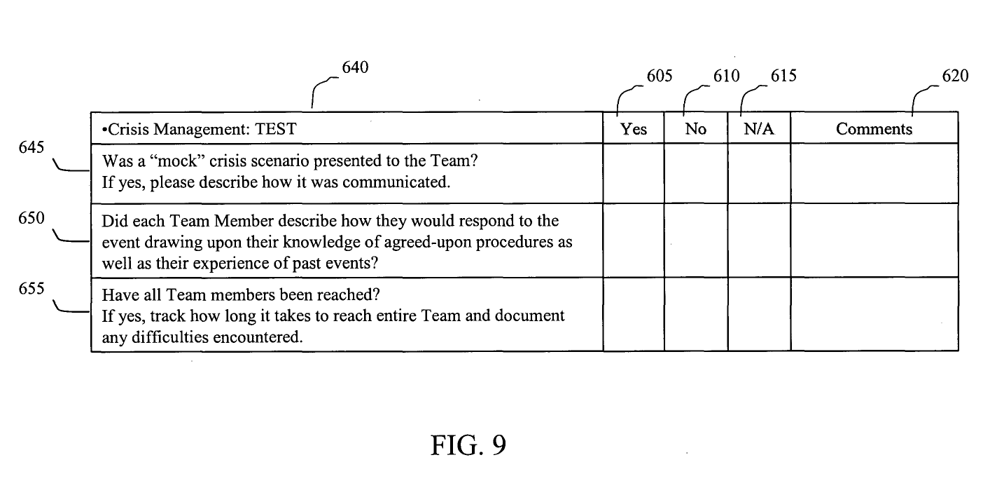

FIG. 9 illustrates an input screen 640 that is used to help the manager assess the testing of the department's crisis management plan. This input screen 640 assumes that the department has already activated a test of the Crisis Management plan. As with input screen 600, the manager can answer the posed questions with a Yes 605, No 610, or Not Applicable 615, and allows the manager to the opportunity enter comments in a Comments field 620 and attach documents or other electronic files to the manager's answer. Input screen 640 specifically asks the manager the following questions with respect to the already conducted test of the department's Crisis Management plan: Was a “mock” crisis scenario presented to the Team? (If yes, please describe how it was communicated.); Did each Team Member describe how they would respond to the event drawing upon their knowledge of agreed-upon procedures as well as their experience of past events?; Have all Team members been reached? (If yes, track how long it takes to reach entire Team and document any difficulties encountered.)

The following describes a scenario for the activation and implementation for the Crisis and BEO plans, In a typical scenario, if the Crisis Management team is activated, then at least one BEO process will be affected and in turn potentially multiple Business Continuity plans. However, if there is an issue at only one of the businesses facilities (i.e., smell of fumes, small contained fire) then Crisis Management and Business Continuity plans will probably not be invoked. To reiterate the criteria for when the crisis team is invoked: The possibility exists for negative press generation; The event has a domino effect causing serious violations of customer service level agreements and/or negative financial impact on the Firm. Delay in delivery causes a ripple effect to all dependent units; An event affects multiple lines of business or support functions simultaneously; A contingency response plan is invoked; An event does not permit a timely recovery as defined by the business unit's continuity plan or defined customer service levels for the affected area; or Business resources, such as facilities, staff, and equipment, needed to perform the business processes, have been permanently or severely disabled. The BEO is building outage focused and is activated once a building has been evacuated. The BEO is responsible for communicating status on building restoration to affected businesses, and coordinating and prioritizing numerous business recovery activities at affective facility.

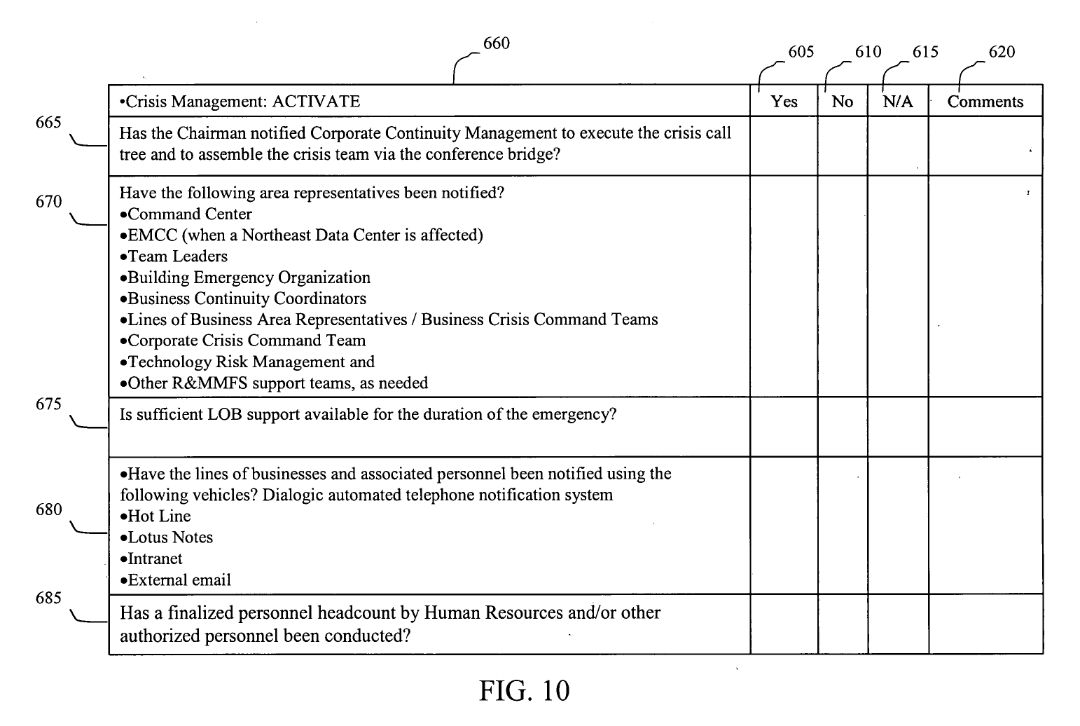

In the event that a Crisis is actually activated, the Crisis Management plan that was assessed and tested and described above is actually activated and executed. Once the plan has been executed (or during it's execution, depending on the crisis) the manager logs onto system 10 in order to input the status of her department. FIG. 10 illustrates the input screen 660 utilized by the manager(s) in the event of an activation of the crisis plan. The data is updated in the LOB specific to the crisis. There is a copy mechanism where the responses can be copy/pasted into other LOBs. However, each manager is responsible for ensuring that the applicable questions have been addressed for his/her LOB. Some questions are N/A or should reflect the response of the Crisis Chairperson.]

Questions 665-685 include: Has the Chairman notified Corporate Continuity Management to execute the crisis call tree and to assemble the crisis team via a conference bridge. The conference bridge is the dial-in telephone line that is used by the senior executive team to provide status and updates to committee. This number is active 24 hours a day and 7 days a week and is always ready for use; Have the following area representatives been notified?: Command Center, Team Leaders Building Emergency Organization, Business Continuity Coordinators, Lines of Business Area Representatives/Business Crisis Command Teams, Corporate Crisis Command Team, and Technology Risk Management; Is sufficient LOB support available for the duration of the emergency?; Have the lines of businesses and associated personnel been notified using the following vehicles?; automated telephone notification system, Hot Line, Lotus Notes; Intranet, and External email; Has a finalized personnel headcount by Human Resources and/or other authorized personnel been conducted? As readily appreciated the questions described above form the preferred embodiment of the present invention and can be modified or additional ones may be added.

The Building Emergency Organization (BEO) project (70 in FIG. 2) has similar input screens with respect the assessment of the department's plan, testing and activation. As previously described, the purpose of the BEO program is to ensure a timely and accurate business recovery and building restoration of an enterprise facility in the event of a disruption that forces the partial, full, temporary or permanent closure of the site. This requires coordination of the numerous activities and personnel required for the business recovery and building restoration at an affected building location. System 10 enable this coordination as well as ensuring that official information regarding the assessment of the building outage and the anticipated recovery times are communicated to affected businesses from that facility.

The BEO itself is the on site group responsible for overseeing the restoration and recovery efforts of the facility and the businesses. In a preferred embodiment, each major facility, worldwide, of the enterprise has a BEO. The BEO itself is comprised of a Business Executive Team and a Support Team. As described above, the Business Executive Team is made up of senior business executives selected to represent the divisions and departments from within that facility. The Support Team members include site representatives from Facilities, Security, Human Resources and Technology Risk Management. Each BEO has a Chairperson, and an Alternate, selected from the Business Executive Team. Each BEO member has a pre-assigned Alternate should he or she not be available.

The BEO uses system 10 to communicate to all affected businesses from that facility, timely and accurate information regarding the assessment of the building outage and the anticipated recovery times. The BEO provides ongoing status reports to the Corporate Crisis Management Team. The BEO Facilities representative represent the interests of third party tenants (if any) and communicate related status.

As with the Crisis Management Program discussed in connection with FIGS. 8, 9 and 10, the BEO program has similar input screens for planning testing and activation. Each of these input screens contains questions that must be answered by the user. Table 1 illustrates the questions contained in the BEO input screen for the planning phase.

TABLE 1
BEO PLAN

Has a floor-by-floor review been performed to ensure all areas of the facil-
ity are represented on the Team?
If yes, provide documented review.
Has a plan been documented to include steps they would take to respond
to the following scenarios:
Building evacuation during normal business hours
Staff arrival to closed building
Building outage outside of normal business hours
(i.e. evenings/weekends)
If yes, provide documented procedure.
Does the HR Representative maintain hard-copy printouts which contains
lists of names and emergency contact information for all FT/PT staff
that are updated quarterly or as needed?
Have communication procedures been established for collecting informa-
tion from evacuated staff members?
If yes, provide documented procedure.
Has an “interim” staging area been identified in a nearby location for the
Team to gather briefly to assess the situation?
If yes, indicate site.
Has a conference call line (and any other telecom or logistical information)
been established for the Team to meet at pre-determined times?
If yes, indicate telephone number.
Are selected assembly areas always available and do they provide suffi-
cient shelter from the elements? (e.g. Street corners are generally a poor
choice due to lack of protection; building lobbies are problematic due to
large amount of traffic).
If yes, identify area.
Are assembly sites large enough to accommodate a full building
evacuation?
If yes, provide accommodation logistics.
Have suitable arrangements (i.e. approvals) been made with the
owners/maintainers of the space, particularly for non-Chase facilities such
as hotels and schools?
If yes, identify terms of agreement and contact information.
Have secure, interior assembly locations been identified and communi-
cated to staff prior to an event?
Have persons been identified with disabilities or other conditions that
would prevent an employee from exiting the building by walking down the
stairs?
If yes, indicate names and locations of the people.
Are appropriate procedures are in place to address any special needs and
are in accordance with applicable Federal guidelines and local fire code
requirements?

Table 2 illustrates the questions contained in the BEO input screen for the testing phase.

TABLE 2
BEO TEST

Was a “mock” crisis scenario presented to the Team?
If yes, please describe how it was communicated.
Did each Team Member describe how they would respond to the event
drawing upon their knowledge of agreed-upon procedures as well as their
experience of past events?
Have all Team members been reached?
If yes, track how long it takes to reach entire Team and document any
difficulties encountered.
Did Team Members exit the premises just as they would during an actual
crisis (e.g. fire stairs)?

Table 3 illustrates the questions contained in the BEO input screen for the activation phase.

TABLE 3
BEO ACTIVATE

Have staff members safely exited the site?
Are staff members' uninjured or have not been referred for medical
treatment/hospital?
If no, provide name and location of hospital.
Have staff members, including contract personnel, been notified of the
incident?
Have staff members been instructed to wait for further instructions, pro-
ceed to contingency sites or sent home?
Are critical business functions or operations able to resume?
If no, describe impact and areas affected.
Are third party service providers (non-JPMC) unaffected/not impacted by
incident?
If no, describe services affected and provider information.

As described above, the final program Business Continuity (75 in FIG. 2) is preferably an integral part of the enterprise's normal business operations. Every manager in the firm should be made responsible for developing and maintaining contingency plans as part of the Business Continuity Program. Minimum requirements are established for each critical business unit to provide essential business and technology services levels. Specifically, the Business Continuity Program uses system 10 to identify critical businesses, infrastructures, operations, and functions. System 10 is further used to identify: the size of staff supporting production vs. contingency; the location and zone for production and contingency; the minimum recovery required (desired presence in the market); the key external dependencies (e.g. counterparts (credit) and infrastructure (processing, Exchanges, outsourcers, utilities, etc.)); any concentration of critical personnel that constitute the core of the JPMC business knowledge; identify high profile buildings within the zone of enterprise facilities (e.g., the Empire State Building).

System 10 is further used to identify and evaluate the risk related to any instance where the production operations environment and the infrastructure-processing center are located within the same enterprise facility zone. System 10 is used to identify and evaluate the risk related to intra-enterprise business dependencies e.g. Shared Services, Lock Box type functions, etc. The existing documented recovery plans for strategy and capacity that exists for each Business, Infrastructure, Operation, and Function are stored in the databases of system 10.

As with the Crisis Management Program discussed in connection with FIGS. 8, 9 and 10, and the BEO program discussed with respect to Table 1, 2 and 4, the Business Continuity Program has similar input screens for planning testing and activation. Each of these input screens contains questions that must be answered by the user. Table 4 illustrates the questions contained in the Business Continuity Program input screen for the planning phase.

TABLE 4
BUSINESS CONTINUITY PROGRAM PLAN

Has an alternate site been selected for processing business functions in the
event the existing location is unavailable?
Is a business continuity plan documented for the resumption of the busi-
ness and service delivery at a different location or in a different way than
normal?
Does the business recovery plan provide the information required to react
to an event, to resume and continue critical business services/functions,
and to ultimately return to business as usual?
Does the plan include the documentation of both the business and associ-
ated technology requirements?
Does the plan account for the loss of critical applications/systems
(e.g. data center outage)?
Based upon an assessment of the risk of failure of all critical
applications/systems that are controlled internally and by any outside
vendors or service providers, does the business continuity plan include
alternate processing that would mitigate these risks in the event of an
extended event?
Are all plan elements in compliance with federal and local regulatory and
legal requirements, as identified by HR, Corporate Legal, and Compliance,
particularly with regard to cross-border strategies and personal informa-
tion?
Is a process in place for maintaining and distributing business continuity
plans which meets the requirements set forth in I/TCP - Policy 6 on
Business Continuity?
Does the plan scope for an outage for a minimum of thirty (30) days?
Has a notification procedure for staff members (JPMC and contractual
personnel) been established?
Have the following individuals (at a minimum) reviewed and approved the
plan?
the key business executive(s) or the department manager(s) of the
business area(s) addressed;
the business continuity coordinator for the business area addressed;
the appropriate technology management, if applicable.
Has the recovery facility (internal or external) been reviewed to insure it
meets I/T Control criteria?
Have the key personnel been identified for activating the business continu-
ity plan?
If yes, identify the key personnel and contact information.
Is a process in place for retrieving vital records from off site storage to
ensure capability to locate and deliver within the required time frame?
Has the annual cost of maintaining a continuity plan been included in the
LOB's budget?

Table 5 illustrates the questions contained in the Business Continuity Program input screen for the test phase.

TABLE 5
BUSINESS CONTINUITY PROGRAM TEST

Have the objective, scope, scheduling, procedures and participants been
defined?
Are test scripts documented and followed, insuring that respective
components have been recovered and restored appropriately?
Are assumptions, accuracy of information, and completeness of procedures
valid?
Are staff members notified of test procedures?
Have recovery capabilities of critical Outside Service Providers been
tested?
Has a summary of the test results been documented which include:
component tested, test result, critical event summary and assigned person-
nel for follow-up items?
Has network connectivity to technical platform been tested?
Are users able to access all of their critical applications?
Is platform restoration performed by retrieving vital records from off-site
storage and restoring onto appropriate platforms (mainframe, midrange,
LAN, desktop)?
Is voice recovery conducted by re-routing critical lines or notification of
new numbers, and where applicable, testing automated call distribu-
tion and recording devices?
Is equipment's capability reviewed to withstand increased access and dial-
in requirements?
Are physical security controls to protect and secure location and assets
reviewed?
Are logical security controls reviewed?
Is data restoration after platform restoration has been completed and
verified acceptable to the business?
Is application verification conducted by testing on-line access to applica-
tion, executing ”critical path” batch schedules, printing reports and
comparing to actual sample production information from the same date?
Are applications tested to ensure performance throughput meets business
requirements?
Are application interfaces (internal, vendor, customer) tested?
Is data synchronized and reconciled, as defined?
Are manual procedures tested in the business that sustained the business
functions/services from time of disaster until business application is
recovered?

Table 6 illustrates the questions contained in the Business Continuity Program input screen for the Activate phase.

TABLE 6
BUSINESS CONTINUITY PROGRAM ACTIVATE

Have staff members, including contract personnel, been notified of the
incident?
Have staff members been instructed to wait for further instructions, pro-
ceed to contingency sites or sent home?
Are critical business functions or operations able to resume?
If no, describe impact and areas affected.
Are third party service providers (non-JPMC) unaffected/not impacted by
incident?
If no, describe services affected and provider information.
Are key resources available during the event? (e.g., recovery seats,
applications and technology infrastructure services, SLAs, third party
contracts)

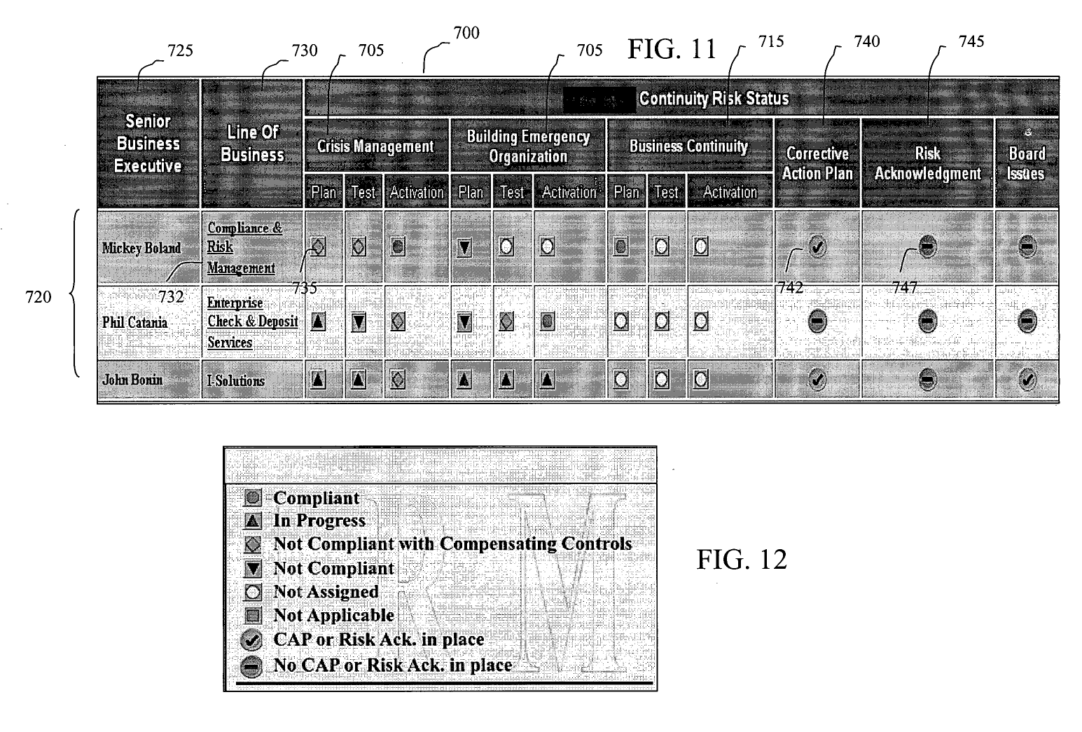

One of the significant features of the present invention is the ability of system 10 to rollup all of the collected information into clear and easily comprehensive status report. FIG. 11 illustrates one such report, in the form of a computer screen, known as a State of Health Report Card 700. This report 700 provides enhanced capabilities to track and monitor key issues and their ongoing progress to close substantial gaps. Report 700 provides the status of the test, plan and activate phases of the programs described above, including corrective actions plans, risk acknowledgments and board issues as further described below. This status screen 700 provides a repository to identify critical incidents and pending resolutions during an even, provides the capability to link the business and technology continuity plans to the crisis team and BEO initiatives across the corporation and serves as a core repository to manage, monitor and measure all core continuity processes.

As seen in FIG. 11, this status screen contains the status of the Plan, Test and Activate phase of each of the Crisis Management 705, Building Emergency Organization 710 and Business Continuity 715 Programs. A record 720 is capable of being displayed for each line of business within the organization (only three illustrated in FIG. 11). For each record 720, the name of the Senior Business Executive 725 and the name of the Line of Business 730 is displayed. The actual name, of the Line of Business 732 is a hyperlink that brings up a status screen comparable to screen 700, except it shows the status of the elements for the next level down in the corporate hierarchy (e.g., the department level). Using this feature, a user is able to drill down (or roll up) to the level of status desired by the particular user.

The status of a particular phase of each of the programs is depicted as a colored icon, e.g., icon 735 in the Planning phase of Crisis Management 705. Each icon represents a different status. In addition to each icon being a different color, it is also a different shape. This allows user having devices without color capability to quickly determine the status of a particular item. FIG. 12 illustrates a legend containing the different icons and their associated statuses.

In the particular statuses depicted in FIG. 11, status 735 indicates that the Plan for Crisis Management 705 is not compliant, but has compensating controls. What this status means is that at least one of the managers for one of the departments in Line of Business 732 had a negative input when assessing the department's plan (see FIG. 8). If the manager has developed a Corrective Action plan, this is indicated in column 740. By clicking on the status icon 742 in the Corrective Action Plan column 740, the user can immediately bring up the CAP developed by the manager. If the manager did not develop a CAP, but rather performed a Risk Acknowledgement, this is indicated in column 745. Similarly, by clicking on the icon 747 in this column 745, the user will be able to see the specific Risk Acknowledgement developed by the manager.

During an exercise or actual event, screen 700 allows access to: real time issue tracking from any location; critical and non-critical staff at primary and secondary locations; and resource identification required to sustain LOB business activity.

An event is a contingency (e.g., fire, flood, etc), that occurs at any of the locations of the business. Whenever a contingency event occurs at any of the business' Facilities, it is displayed on a screen of system 10 alongside all LOBs that are impacted by this event. [Note to inventors: Can I get this screen as well the Add/Modify and View screens] This display occurs in real time so that prompt action can be taken to deal with the event. On clicking the ‘Facility Event’ link on the toolbar, users are given the option two options: (1) Add/Modify event; and (2) View Event.

Events are added for a Chase Facility. On clicking ‘Add/Modify Event’, the user drills down to the specific Chase Facility (building) (same as for BEO Wallet Cards) and fills up a form for adding an event. The form contains a table with the following columns:

| | | Esti- | Resource/ | | |
|---|---|---|---|---|---|
| | | mated | organization | | |
| | | Recov- | responsible | Respon- | |
| | | ery | for | sible | |
| Factor | Rating | Time | assessment | Personnel | Comments |
| Standard | Pass | Entry of | Picked from a | Ability to | Facility for |
| items | or Fail | Date | drop down list | pick from | entering |
| available | to be | and | box. Ability | eSource | comments |
| on the | chosen | time | to be provided | | |
| form | | (Calen- | to add a new | | |
| | | dar | entry into the | | |
| | | with | box. | | |
| | | time | | | |
| | | option | | | |
| | | to be | | | |
| | | give to | | | |
| | | the | | | |
| | | user) | | | |

The above form has a facility for adding an attachment. Any special comments or issues about an event can be filled in by the user, in the attachment. An event is invoked (or generated) by selecting the option ‘Fail’, under the Rating column against the appropriate factor. Several LOBs located within that facility would now get impacted by the event. This is displayed as a ‘non compliant’ icon on the SOH page of the LOB under the Event column and rolled up to the Continuity SOH page. From the SOH page, on clicking the ‘non compliant’ icon, the user is shown a listing and details of all events impacting that LOB. All items as captured in the above form are to be displayed, facility-wise. The name of the person who entered the Event into the system are also to be displayed. From the same form shown above, the user has the option of ‘closing’ the event. Events can be closed by changing their status to ‘Pass’. On closing the event, the corresponding icons on the SOH page should turn back to ‘compliant’. (2) View Event: On clicking ‘View Event’, a form is displayed have the following items that the user can choose from: Event Location: All locations or the option to select a specific location; Dates: From and To Dates; Status: All, Open or Closed. Thus, the user can either choose to view events at a particular location or at all locations, events that fall within a specific time frame and events that are open or closed or all events, and various combinations (‘and’ combination only) among the above three options. For example: A user can choose to get details of all events at all locations that have been ‘closed’, between a set of dates. On clicking submit, the complete details as captured in the ‘Add Event’ form are displayed, facility-wise. The name of the person who entered the Event into the system and the person who ‘closed’ the event are also to be displayed.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

We claim:

1. A method for providing business continuity in an enterprise comprising:
collecting resource information, the resource information describing at least one resource used by the enterprise;
storing in a database resource information describing the at least one resource;
assessing a criticality of the at least one resource;
storing the assessment of the criticality of the at least one resource in the database;
developing a recovery plan for recovery from a loss of use of the at least one resource;
storing the recovery plan in the database;
assessing the recovery plan;
storing the assessment of the recovery plan in the database;
testing the recovery plan and recording the results of the testing;
storing the recorded results of the testing in the database; and
providing status data from the database, wherein the status data comprises at least one of a status of: the collection of the resource data; the assessment of the criticality; the development of the recovery plan; and the testing of the recovery plan.

2. The method according to claim 1, wherein the at least one resource is a department within the enterprise, the step of collecting resource information further comprises at least one of:
collecting resource information with respect to the department name;
collecting resource information with respect to the department manager;
collecting resource information with respect to a primary location of the department;
collecting resource information with respect to a recovery location of the department;
collecting resource information with respect to products and services provided by the department;
collecting resource information with respect to a total number of production seats required by the department; and
collecting resource information with respect to a number of specialized production seats required by the department.

3. The method according to claim 2, wherein a loss of use of the primary location is assumed, the steps of collecting resource information with respect to the total number of production seats and the specialized production seats further comprises at least one of:
determining how many of each type of seat is required a same day as the loss of use of the primary location;
determining how many of each type of seat is required a day after the loss of use of the primary location;
determining how many of each type of seat is required a week after the loss of use of the primary location; and
determining how many of each type of seat is required a month after the loss of use of the primary location.

4. The method according to claim 1, wherein the at least one resource is a department within the enterprise, the step of collecting resource information further comprises at least one of:
collecting resource information with respect to the department name;
collecting resource information with respect to the department manager;
collecting resource information with respect to a primary location of the department;
collecting resource information with respect to a recovery location of the department;
collecting resource information with respect to products and services provided by the department;
collecting resource information with respect to a total number of production seats required by the department; and
collecting resource information with respect to a number of specialized production seats required by the department.

5. The method according to claim 1, wherein the at least one resource is a department within the enterprise, the step of collecting resource information further comprises at least one of:
collecting resource information with respect to software applications relied on by the department; and
collecting resource information with respect to external vendors relied on by the department.

6. The method according to claim 1, wherein the at least one resource is a department within the enterprise, wherein as part of the step of assessing the criticality of the department, a degradation of a functionality of the department is assumed, the step of assessing the criticality of the department further comprises at least one of:
assessing an impact on external customers of the enterprise resulting from the degradation of the functionality of the department;
assessing an impact on internal customers of the enterprise resulting from the degradation of the functionality of the department;
assessing a financial impact resulting from the degradation of the functionality of the department;
assessing an allowable time period that the degradation of the functionality of the department can last;
assessing an impact on regulatory obligations resulting from the degradation of the functionality of the department; and
assessing an impact on legal obligations resulting from the degradation of the functionality of the department.

7. The method according to claim 1, further comprising:
assigning specific people to fulfill roles in a case of interruption of the business of the enterprise, wherein the roles include at least one of: building emergency organization chairperson; business executive; facilities regional manager; and human resources coordinator.

8. The method according to claim 7, further comprising:
receiving acknowledgements of the acceptances of the assignments from the specific people.

9. The method according to claim 7, further comprising:
assigning alternate people to fulfill the roles.

10. The method according to claim 7, wherein the role of building emergency organization chairperson comprises at least one of:
overseeing recovery activities in the event of an emergency;
providing status on the recovery activities;
prioritize resumption of critical functions; and
compiling a list of all business units in a facility and their designated assembly areas, and recovery sites.

11. The method according to claim 7, wherein the role of business executive comprises at least one of:
assessing the enterprise's risk exposures as a result of an emergency;
declaring a disaster recovery condition; and
prioritizing the reentry of employees to the building.

12. The method according to claim 7, wherein the role of facilities regional manager comprises at least one of:
ordering partial or total evacuation of a facility;
determining an anticipated length of the outage of a facility;
supervising activities to restore the facility;
providing status of the facility;
coordinating with local police, fire and other public safety officials;

13. The method according to claim 7, wherein the role of human resources coordinator comprises at least one of:
accounting for employees in an emergency at a facility;
coordinating activities to seek out employees who are not accounted for in the emergency;
generating lists of names and employee contact information for employees at the affected facility; and
maintaining hard-copy printouts of employee contact information.

14. The method according to claim 1, wherein the at least one resource is a department within the enterprise, the step of collecting resource information further comprises:
collecting employee resource information with respect to the employees of the department, the employee resource information including at least three of: the employee's name; primary work location; primary work region; primary work phone number; primary work facsimile number; pager number; pager Personal Identification number; cellular phone number; home phone number; alternate home phone number; personal Internet addresses; alternate work location; alternate work address; and alternate work phone number.

15. The method according to claim 14, further comprising:
generating a wallet card for the employee using the employee resource information, wherein the wallet card is generated at a workstation of the employee.

16. The method according to claim 15, wherein the wallet card contains a hotline, a website, and at least one emergency location that the employee can use in an emergency.

17. The method according to claim 1, wherein all of the steps of the are facilitated using a software application, the method further comprising:
generating data input screens for accepting input from a user; and
providing drop down boxes on the data input screens in order to facilitate selection of predefined information.

18. The method according to claim 1, wherein the step of assessing the recovery further comprises:
questioning the developer of the plan as to whether it has required elements; and
developing a corrective action plan to address missing required elements.

19. The method according to claim 1, wherein the step of providing status data further comprises:
providing status data on the enterprise level;
providing status data on a line of business level; and
providing status data on a department level.

20. A method for providing business continuity in an enterprise in the event of an emergency, the method comprising:
collecting employee information with respect to employees of the enterprise, the employee information including at least the employee's name;
storing the employee information in a database;
activating an automated voice response unit during the emergency;
receiving a phone call from an employee;
verifying the employee's identity; and
automatically storing in the database an indication that the employee has phoned the automated voice response unit.

21. The method according to claim 20, further comprising:
collecting personal identification information from the employee;
storing the personal identification information in the database; and
wherein the verifying step further comprises asking the employee to verify the previously collected personal identification information.

22. The method according to claim 21, wherein the personal identification information comprises the last four digits of the employee's social security number.

23. The method according to claim 20, wherein the employee information stored in the database is organized by departments within the enterprise, and wherein the employee information includes the employee's department, the method further comprising:
asking the employee on the phone to identify the employee's department; and
retrieving the employee information related to that employee from the database.

24. The method according to claim 20, further comprising:
retrieving from the database a status as to whether employees have phoned the voice response unit.

25. The method according to claim 20, wherein employee information includes contact information related to employees, the method further comprising:
using the contact information to contact an employee if the status indicates that the employee has not phoned the voice response unit.

26. The method according to claim 25, wherein the contact information includes at least one of: a primary work phone number; a primary work facsimile number; a pager number; a pager Personal Identification Number; a cellular phone number; a home phone number; an alternate home phone number; a personal Internet addresses; and an alternate work phone number.

27. A system for providing business continuity in an enterprise comprising:
a user interface for interfacing with users of the system;
at least one database server and at least one application server coupled to the user interface; and
at least database and at least one application respectively coupled to the database server and the application server;
wherein the system is programmed to:
collect resource information, the resource information describing at least one resource used by the enterprise;
store in the database, resource information describing the at least one resource;
assess a criticality of the at least one resource;
store the assessment of the criticality of the at least one resource in the database;
store in the database, a recovery plan for recovery from a loss of use of the at least one resource;
assess the recovery plan;
storing, in the database, the assessment of the recovery plan;
record in the database, results of testing the recovery plan; and
provide status data from the database, wherein the status data comprises at least one of a status of: the collection of the resource data; the assessment of the criticality; the development of the recovery plan; and the testing of the recovery plan.

28. The system according to claim 27, wherein the at least one resource is a department within the enterprise, wherein the user interface is used to collect at least one of the following resource information:
resource information with respect to the department name;
resource information with respect to the department manager;
resource information with respect to a primary location of the department;
resource information with respect to a recovery location of the department;
resource information with respect to products and services provided by the department;
resource information with respect to a total number of production seats required by the department; and
resource information with respect to a number of specialized production seats required by the department.

29. The system according to claim 28, wherein a loss of use of the primary location is assumed, the resource information with respect to the total number of production seats and the specialized production seats further comprises at least one of:
the number of each type of seat that is required a same day as the loss of use of the primary location;
the number of each type of seat that is required a day after the loss of use of the primary location;
the number of each type of seat that is required a week after the loss of use of the primary location; and
the number of each type of seat that is required a month after the loss of use of the primary location.

30. The system according to claim 27, wherein the at least one resource is a department within the enterprise, wherein the user interface is used to collect at least one of the following resource information:
resource information with respect to the department name;
resource information with respect to the department manager;
resource information with respect to a primary location of the department;
resource information with respect to a recovery location of the department;
resource information with respect to products and services provided by the department;
resource information with respect to a total number of production seats required by the department; and
resource information with respect to a number of specialized production seats required by the department.

31. The system according to claim 27, wherein the at least one resource is a department within the enterprise, wherein the user interface is used to collect at least one of the following resource information:
resource information with respect to software applications relied on by the department; and
resource information with respect to external vendors relied on by the department.

32. The system according to claim 27, wherein the at least one resource is a department within the enterprise, wherein the assessment of the criticality of the department assumes a degradation of a functionality of the department, the assessment of the criticality of the department further comprises at least one of:
an assessment of an impact on external customers of the enterprise resulting from the degradation of the functionality of the department;
an assessment of an impact on internal customers of the enterprise resulting from the degradation of the functionality of the department;
an assessment of a financial impact resulting from the degradation of the functionality of the department;
an assessment of an allowable time period that the degradation of the functionality of the department can last;
an assessment of an impact on regulatory obligations resulting from the degradation of the functionality of the department; and
an assessment of an impact on legal obligations resulting from the degradation of the functionality of the department.

33. The system according to claim 27, wherein the database further includes:
an assignment of specific people to fulfill roles in a case of interruption of the business of the enterprise, wherein the roles include at least one of: building emergency organization chairperson; business executive; facilities regional manager;
and human resources coordinator.

34. The system according to claim 33, wherein the database further includes acknowledgements of the acceptances of the assignments from the specific people.

35. The system according to claim 33, wherein the database further includes an assignment of alternate people to fulfill the roles.

36. The system according to claim 27, wherein the at least one resource is a department within the enterprise, wherein the user interface is used to collect at least one of the following resource information:
employee resource information with respect to the employees of the department, the employee resource information including at least three of: the employee's name; primary work location; primary work region; primary work phone number; primary work facsimile number; pager number; pager Personal Identification number; cellular phone number; home phone number; alternate home phone number; personal Internet addresses; alternate work location; alternate work address; and alternate work phone number.

37. The system according to claim 36, further comprising:
an employee workstation that generates a wallet card for the employee using the employee resource information.

38. The system according to claim 27, further comprising:
an employee hotline and an employee website that the employee can use in an emergency.

39. The system according to claim 27, wherein the user interface further comprises:
data input screens for accepting input from a user; and
drop down boxes on the data input screens in order to facilitate selection of predefined information.

40. The system according to claim 27, wherein the database further includes a corrective action plan to address missing required elements in the recovery plan.

41. The system according to claim 27, wherein the status data further comprises:
status data on the enterprise level;
status data on a line of business level; and
status data on a department level.

42. A system for providing business continuity in an enterprise in the event of an emergency, the system comprising:
a user interface for colleting employee information with respect to employees of the enterprise, the employee information including at least the employee's name;
a database for storing the employee information; and
an automated voice response unit coupled to the database, wherein the automated voice response unit is activated during the emergency, receives a phone call from an employee, verifies the employee's identity and automatically stores in the database an indication that the employee has phoned the automated voice response unit.

43. The system according to claim 42, wherein the user interface collects personal identification information from the employee and stores the personal identification information in the database; and
wherein the automated voice response unit asks the employee to verify the previously collected personal identification information.

44. The system according to claim 43, wherein the personal identification information comprises the last four digits of the employee's social security number.

45. The system according to claim 42, wherein the employee information stored in the database is organized by departments within the enterprise, and wherein the employee information includes the employee's department, the automated voice response unit:
asking the employee on the phone to identify the employee's department; and
retrieving the employee information related to that employee from the database.

46. The system according to claim 42, wherein the user interface is capable of retrieving from the database a status as to whether employees have phoned the voice response unit.
